(19) United States
(12) Patent Application Publication
(10) Pub. No.: US 2002/0096837 A1
(43) Pub. Date: Jul. 25, 2002

(54) Seal for a shaft, in particular for a generator shaft

(76) Inventors: Wolfgang Brunnstein, Oer-Erkenschwick (DE); Alexander Longree, Koln (DE); Helmut Rehm, Oberhausen (DE); Ralf Ronnebeck, Schonungen (DE)

Correspondence Address: LERNER AND GREENBERG, P.A., Post Office Box 2480, Hollywood, FL, 33022-2480, US

(21) Appl. No.: 10/066,876

(22) Filed: Feb. 4, 2002

Related U.S. Application Data
(63) Continuation of application No. PCT/EP00/07254, filed on Jul. 27, 2000.

(30) Foreign Application Priority Data
Aug. 3, 1999 (EP) 99 115 339.6

(51) Int. Cl. F16J 15/40

(52) U.S. Cl. 277/431

(57) ABSTRACT

A seal provides for the gastight separation of a cooling-gas side and an air side of a shaft, in particular a generator shaft, including an annular basic body having a sealing ring and an outlet for a sealing oil. The sealing oil forms an oil film in a radial gap between the sealing ring and the shaft. The sealing ring has segments made of a heat-resistant plastic or of a soft brass alloy which are disposed at the interior of the sealing ring facing the shaft. The plastic or soft brass alloy acts as an emergency lubricant in the event that the shaft comes into contact with the sealing ring. The segments are releasably fastened to the basic body, so that they can easily be exchanged. The basic body is preferably formed of two half-shell bodies.

### CROSS-REFERENCE TO RELATED APPLICATION

This application is a continuation of copending International Application No. PCT/EP00/07254, filed Jul. 27, 2000, which designated the United States.

### BACKGROUND OF THE INVENTION

1. Field of the Invention

The invention relates to a seal for a shaft, in particular for the shaft of a gas-cooled generator, including a sealing ring having an interior with an emergency lubricant. An outlet is provided through which sealing oil can be introduced into a radial gap between the sealing ring and the shaft.

A shaft seal of that type is known from German Published, Non-Prosecuted Patent Application DE 37 23 729 A1 and from German Patent DE 196 39 978 C1, corresponding to International Publication No. WO 98/13630. The known shaft seal is constructed in the form of a disk. The shaft seal ensures a leak-tight leadthrough of the rotating shaft through a casing, for example the casing of a generator, which is filled with gas under a predetermined pressure. For that purpose, the sealing ring is held between a guide plate and a relief flange connected through stud bolts to the guide plate. In that version, the shaft seal is disposed on the shaft in the installed state in such a way that the guide plate faces the casing and is therefore disposed on the “cooling-gas side” of the sealing ring, while the relief flange is located on what is referred to as the “air side” of the sealing ring.

Sealing oil is introduced through an outlet into the radial gap between the sealing ring and the shaft in order to seal off the rotating shaft. In that case, the sealing oil forms an oil film which, on one hand, prevents cooling gas from going over from the cooling-gas side to the air side and, on the other hand, also prevents air from flowing over from the air side to the cooling-gas side.

The sealing ring that was used heretofore had been one which was formed of steel or brass and was provided with an emergency lubricant at its interior. The emergency lubricant used heretofore had been a white metal. The metal is a sliding-bearing alloy which is formed of Sn, Sb, Cu, Zn and Ag. Such a sliding-bearing alloy is offered under the name TEGOSTAR 738 by the company Goldschmitt of Essen, Germany. That white metal is soft and deformable at about 180° C. In the event of contact of the sealing ring with the shaft, it serves the task of preventing damage to the shaft through the use of its emergency lubrication properties. The white metal is applied by coating. However, the coating of the sealing ring with the white metal is relatively cost-intensive. Moreover, problems arising during operation, for example cracking open or cracking off of the white metal, repeatedly manifest themselves.

### SUMMARY OF THE INVENTION

It is accordingly an object of the invention to provide a seal for a shaft, in particular for a generator shaft, which overcomes the hereinafore-mentioned disadvantages of the heretofore-known devices of this general type, which can be produced in a less complicated and therefore more cost-effective way and in which an emergency lubricant is capable of being fastened reliably to the inside of a sealing ring.

With the foregoing and other objects in view there is provided, in accordance with the invention, a seal for a shaft, in particular for the shaft of a gas-cooled generator, comprising a basic body having a sealing ring spaced apart from the shaft and defining a radial gap between the sealing ring and the shaft. The sealing ring has an interior and an outlet for introducing sealing oil into the radial gap. An emergency lubricant is in the form of segments of a material which is a heat-resistant plastic or a soft metal alloy or soft brass alloy. The emergency lubricant is disposed in the interior of the sealing ring and releasably fastened to the basic body.

Therefore, a heat-resistant plastic or a brass alloy is used in this case instead of white metal, and a releasable fastening is provided instead of a coating. As compared with white metal, the plastic which can be used in this case has the advantage of being deformable only at a temperature higher than 180° C. It should, however, have similar lubrication properties. The same applies accordingly to the soft brass alloy which can be used in this case. Those materials should have a hardness/break value (HB value) of lower than or equal to 40.

In accordance with another feature of the invention, the segments are fastened to the basic body through the use of bolts or screws, which are preferably countersunk in the basic body. This structure thus results in relatively simple mountability and demountability.

In accordance with a further feature of the invention, the segments are two half shells. Four quarter shells or a number of other fractions may, of course, also be used. It is also possible to fasten the segments to the basic body in two or more parallel circular rows.

In accordance with an added feature of the invention, the segments can be removed from the basic body in the axial direction of the shaft. This can be achieved, for example, when the basic body is formed of two half-shell bodies which are fastened to one another when the shaft is in operation and can be removed from one another during the demounting of the segments.

In accordance with an additional feature of the invention, the plastic which is used is a polyether ether ketone material (PEEK material) or is carbon-fiber-reinforced.

In accordance with yet another feature of the invention, the segments can be removed by being lifted off the basic body.

In accordance with yet a further feature of the invention, the outlet for introducing sealing oil is disposed approximately centrally in the sealing ring, as seen in longitudinal direction of the shaft.

In accordance with yet an added feature of the invention, the basic body is formed of a steel or brass material.

In accordance with a concomitant feature of the invention, there are provided sockets each holding a respective one of the segments on the basic body.

Depending on the embodiment, the following advantages may be noted: the stocking of replacement parts is simplified, since only the segments have to be kept in stock. Moreover, a rapid reconstruction of the sealing ring at the assembly site is ensured, because only the segments have to be exchanged. The previously necessary further processing of a sealing ring, having coated emergency lubricant, through the use of special tools in a repair workshop sometimes situated at a great distance, is no longer required. Furthermore, a simplified manufacture of the sealing ring is obtained, since there is no need for very high surface quality on the surface facing the shaft. The basic body of the sealing ring can be used repeatedly since, as stated, only the segments have to be exchanged.

The following is also important: since the plastic or brass alloy can be subjected to higher thermal load than the white metal used previously, the radial gap between the sealing ring and the shaft can be reduced. It can now amount to less than 0.3 mm, for example. In other words: the total play between the sealing ring and the shaft can amount to less than 0.3 mm. The required quantity of sealing oil is thereby reduced. As a result, the discharge of gas, that is to say, for example, of hydrogen in the case of a gas-cooled generator, is also reduced. Therefore, only a relatively small system is also required for delivering the sealing oil into the radial gap.

Other features which are considered as characteristic for the invention are set forth in the appended claims.

Although the invention is illustrated and described herein as embodied in a seal for a shaft, in particular for a generator shaft, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a fragmentary, diagrammatic, longitudinal axial-sectional view of a shaft seal for a shaft of a gas-cooled generator; and

FIG. 2 is a cross-sectional view through the shaft seal, on a different scale, which is taken along a line II-II in FIG. 1, in the direction of the arrows.

### DESCRIPTION OF THE PREFERRED EMBODIMENTS

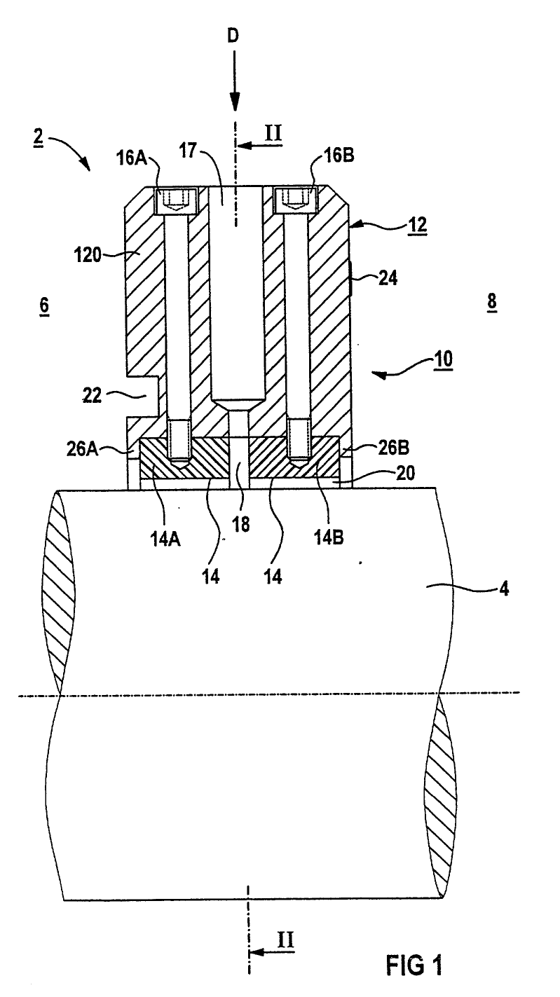

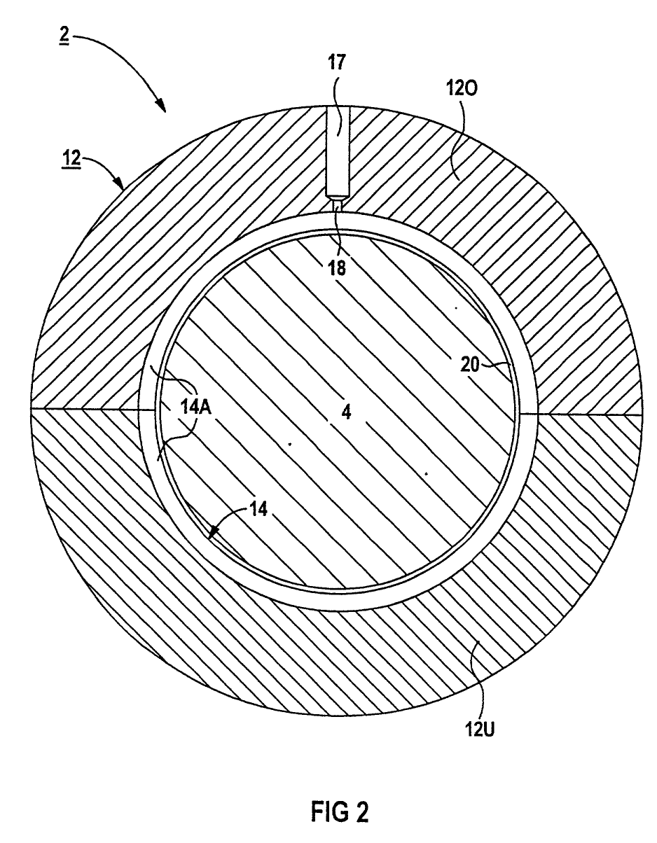

Referring now in detail to FIGS. 1 and 2 of the drawings as a whole, there is seen a seal 2 for a shaft 4 of a gas-cooled generator which, for example, is an integral part of a power plant. The seal 2 serves for separating a cooling-gas side 6, in particular a hydrogen side, from an air side 8. The seal 2 therefore ensures that no hydrogen passes from the cooling-gas side 6 onto the air side 8 and, conversely, that no air flows over from the air side 8 to the cooling-gas side 6.

The seal 2 includes an essential structural element in the form of a sealing ring 10. The sealing ring 10 is formed of an annular basic body 12 and of segmental pieces or segments 14 which are made of plastic or of a soft brass alloy (HB value lower than or equal to 40) and are disposed on the inside of the sealing ring 10, that is to say facing the shaft 4.

The basic body 12 is preferably formed of steel or of brass. The basic body 12 includes two half rings or half shells 12 O and 12 U which are fastened in such a way as to be braced against one another. As illustrated, the segments 14 may, in particular, be two parallel rows of segments 14A, 14B, especially of half shells. The segments are releasably fastened to the basic body 12 through the use of countersunk screws 16A, 16B. Quarter shells or segments having a different configuration may, of course, also be used. The segments 14A, 14B, which are made of heat-resistant plastic or of soft brass alloy, serve as an emergency lubricant. They are intended to prevent contact by the metallic basic body 12 with the shaft 4, which in any event rotates at 3000 revolutions per minute. The segments therefore prevent damage to the shaft 4. The plastic may be a carbon-fiber-reinforced plastic. A polyether ether ketone or PEEK material has proved to be a suitable plastic. Such a material may be obtained under the designation “TECAPEEK mod” from the company Ensinger GmbH & Co., DE-71154 Nutringen, Germany. The material has similarly good lubrication properties to white metal.

A feed line or inflow 17, which is provided in the middle of the basic body 12 for supplying sealing oil D, meets the shaft 4 at an outlet 18 between the two rows of segments 14A and 14B. The sealing oil D is introduced through this outlet 18 into a radial gap 20 between the sealing ring 10 and the shaft 4. This radial gap 20 is relatively narrow and its width may amount to less than 1 mm, even to less than 0.3 mm. The sealing oil D forms an oil film in the radial gap 20 which prevents the above-mentioned overflow of gas from one side to the other side. The sealing oil D is fed externally from a sealing-ring holder.

In the prior art according to German Patent DE 196 39 978 C1, corresponding to International Publication No. WO 98/13630, a non-illustrated guide plate may be disposed on the left side of the sealing ring 10 in FIG. 1 and a non-illustrated relief flange may be disposed on the right side. In order to seal the non-illustrated guide plate, a place, in that case especially a groove 22, is provided for an additional or secondary seal in the basic body 12. A place where a further additional seal is provided when the non-illustrated relief flange is applied, is designated by reference numeral 24.

It is very important, then, that a damaged segment 14A, 14B can be exchanged for a new one even at the site of the generator. When the generator is at a standstill, the countersunk bolts or screws 16A, 16B are to be released for this purpose. This is expediently carried out after the two half rings or half shells 12 O, 12 U of the basic body 12 have been removed from one another. The segments 14A, 14B can then be removed in the axial direction of the shaft 4. Sockets 26A, 26B are provided on an inner part of the basic body 12 in order to make it easier to install new segments 14A, 14B. These sockets 26A, 26B thus serve for holding the respective elements 14A and 14B before they are firmly installed.

It should be emphasized, once again, that a radially and axially divided sealing-ring holder is important for simple demounting (at a standstill).

The illustrated embodiment is suitable particularly for a turbogenerator.

We claim:

1. A seal for a shaft, comprising:
a basic body having a sealing ring spaced apart from the shaft and defining a radial gap between said sealing ring and the shaft;
said sealing ring having an interior and an outlet for introducing sealing oil into said radial gap; and
an emergency lubricant in the form of segments of a material selected from the group consisting of a heat-resistant plastic and a soft metal alloy, said emergency lubricant disposed in said interior of said sealing ring and releasably fastened to said basic body.

2. The seal according to claim 1, wherein said segments are two half shells.

3. The seal according to claim 1, wherein said segments are fastened to said basic body in two parallel rows.

4. The seal according to claim 1, including screws fastening said segments to said basic body.

5. The seal according to claim 4, wherein said screws are countersunk in said basic body.

6. The seal according to claim 1, wherein said material of said segments is a carbon-fiber-reinforced plastic.

7. The seal according to claim 1, wherein said material of said segments is a polyether ether ketone plastic.

8. The seal according to claim 1, wherein said segments are configured to be removed by being lifted off said basic body.

9. The seal according to claim 1, wherein said basic body includes two half-shell bodies fastened to one another during operation of the shaft.

10. The seal according to claim 8, wherein said basic body includes two half-shell bodies fastened to one another during operation of the shaft.

11. The seal according to claim 1, wherein said outlet for introducing sealing oil is disposed approximately centrally in said sealing ring, as seen in longitudinal direction of the shaft.

12. The seal according to claim 1, wherein said basic body is formed of a material selected from the group consisting of steel and brass.

13. The seal according to claim 1, including sockets each holding a respective one of said segments on said basic body.

14. A seal for a gas-cooled generator shaft, comprising:
a basic body having a sealing ring spaced apart from the generator shaft and defining a radial gap between said sealing ring and the generator shaft;
said sealing ring having an interior and an outlet for introducing sealing oil into said radial gap; and
an emergency lubricant in the form of segments of a material selected from the group consisting of a heat-resistant plastic and a soft metal alloy, said emergency lubricant disposed in said interior of said sealing ring and releasably fastened to said basic body.
